(19) United States
(12) Patent Application Publication
(10) Pub. No.: US 2006/0291832 A1
(43) Pub. Date: Dec. 28, 2006

(54) Heat treatment apparatus of light emission type

(75) Inventor: Yoshio Ito, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg., Co., Ltd.

(21) Appl. No.: 11/416,018

(22) Filed: May 2, 2006

(30) Foreign Application Priority Data
May 2, 2005 (JP) JP2005-134148

(51) Int. Cl. A21B 2/00; F26B 19/00

(52) U.S. Cl. 392/416

(57) ABSTRACT

A flash of light emitted from flash lamps is directed through an optical window defined by an opening provided in a clamp ring onto a semiconductor wafer. Because the opening of the clamp ring is of an elliptical configuration, the optical window defined by the clamp ring is also of an elliptical plan configuration. The clamp ring is mounted to a chamber so that opposite edge portions of the optical window facing parts of a peripheral portion of the semiconductor wafer which have a relatively low temperature if a flash of light is directed from the flash lamps through the optical window, assuming that the optical window is of a circular plan configuration, are opposite edge portions of the optical window which are located on the minor axis of the elliptical configuration. Directing the flash of light through the optical window increases the temperature of the parts of the peripheral portion having the relatively low temperature to improve the within-wafer uniformity of a temperature distribution of the semiconductor wafer during flash heating.

### BACKGROUND OF THE INVENTION

1. Field of the Invention

The present invention relates to a heat treatment apparatus for exposing a substrate including a semiconductor wafer, a glass substrate for a liquid crystal display device and the like to a flash of light to heat-treat the substrate.

2. Description of the Background Art

Conventionally, a lamp annealer employing a halogen lamp has been typically used in the step of activating ions in a semiconductor wafer after ion implantation. Such a lamp annealer carries out the activation of ions in the semiconductor wafer by heating (or annealing) the semiconductor wafer to a temperature of, for example, about 1000° C. to about 1100° C. Such a heat treatment apparatus utilizes the energy of light emitted from the halogen lamp to raise the temperature of a substrate at a rate of about hundreds of degrees per second.

In recent years, with the increasing degree of integration of semiconductor devices, it has been desired to provide a shallower junction as the gate length decreases. It has turned out, however, that even the execution of the process of activating ions in a semiconductor wafer by the use of the above-mentioned lamp annealer which raises the temperature of the semiconductor wafer at a rate of about hundreds of degrees per second produces a phenomenon in which the ions of boron, phosphorus and the like implanted in the semiconductor wafer are diffused deeply by heat. The occurrence of such a phenomenon causes the depth of the junction to exceed a required level, giving rise to an apprehension about a hindrance to good device formation.

To solve the problem, there has been proposed a technique for exposing the surface of a semiconductor wafer to a flash of light by using a xenon flash lamp and the like to raise the temperature of only the surface of the semiconductor wafer implanted with ions in an extremely short time (several milliseconds or less). The xenon flash lamp has a spectral distribution of radiation ranging from ultraviolet to near-infrared regions. The wavelength of light emitted from the xenon flash lamp is shorter than that of light emitted from the conventional halogen lamp, and approximately coincides with a basic absorption band of a silicon semiconductor wafer. It is therefore possible to rapidly raise the temperature of the semiconductor wafer, with a small amount of light transmitted through the semiconductor wafer, when the semiconductor wafer is exposed to a flash of light emitted from the xenon flash lamp. Also, it has turned out that a flash of light emitted in an extremely short time of several milliseconds or less can achieve a selective temperature rise only near the surface of the semiconductor wafer. Therefore, the temperature rise in an extremely short time by using the xenon flash lamp allows the execution of only the ion activation without deeply diffusing the ions.

In a heat treatment apparatus employing such xenon flash lamps, the area in which the plurality of xenon flash lamps are arranged is much greater than the area of the semiconductor wafer. Nevertheless, the illuminance in a peripheral portion of the semiconductor wafer is somewhat lower than that in an inner portion thereof. In particular, a wafer having a diameter as large as 300 mm exhibits a large degree of lowering in illuminance in the peripheral portion thereof to result in the poor uniformity of a within-wafer illuminance distribution.

To solve such a problem, Japanese Patent Application Laid-Open No. 2004-140318 discloses a heat treatment apparatus in which a geometrical pattern of ground glass is formed in a region of a diffuser provided between xenon flash lamps and a semiconductor wafer, the region being positioned over a portion (or inner portion) other than a peripheral portion of the semiconductor wafer. Thus, this heat treatment apparatus decreases the light transmittance of the region to decrease the illuminance in the inner portion of the semiconductor wafer during flash heating, consequently providing a uniform within-wafer illuminance distribution.

However, it has been found that a heat treatment apparatus employing a xenon flash lamp presents not only the non-uniformity of a temperature distribution in a radial direction of the semiconductor wafer but also the non-uniformity of a temperature distribution in a circumferential direction of the semiconductor wafer having the same radius. Specifically, there have been cases in which the temperature of only part of the peripheral portion of the semiconductor wafer is decreased. For elimination of such non-uniformity of the temperature distributions, it is impossible to adjust the light source of the xenon flash lamp. It is also difficult for a hot plate for preheating the semiconductor wafer prior to the flash heating to eliminate the non-uniformity of the temperature distribution in the circumferential direction of the semiconductor wafer having the same radius.

### SUMMARY OF THE INVENTION

The present invention is intended for a heat treatment apparatus for exposing a substrate to a flash of light to heat the substrate.

According to one aspect of the present invention, the heat treatment apparatus comprises: a light source including a plurality of flash lamps arranged in a plane; a chamber provided under the light source for receiving a substrate therein; a holding element for holding the substrate within the chamber; a light-transmittable plate provided in an upper portion of the chamber for introducing a flash of light emitted from the light source into the chamber; and an optical window forming member for defining an optical window, the optical window being a region of the light-transmittable plate through which light actually passes, the optical window having a plan configuration such that a distance between the center of the optical window and an edge portion of the optical window is shorter than a distance between the center of the optical window and any other edge portion of the optical window.

The heat treatment apparatus is capable of increasing the temperature of part of a substrate peripheral portion close to the above-mentioned edge portion when the substrate is exposed to the flash of light to improve the within-wafer uniformity of a temperature distribution of the substrate during the heat treatment, especially the temperature distribution uniformity in the substrate peripheral portion.

Preferably, the edge portion of the optical window is an edge portion facing part of a substrate peripheral portion having a relatively low temperature if a flash of light is directed from the light source through the optical window, assuming that the optical window is of a circular plan configuration.

The heat treatment apparatus is capable of increasing the temperature of the part of the substrate peripheral portion having the relatively low temperature to improve the temperature distribution uniformity in the substrate peripheral portion.

According to another aspect of the present invention, the heat treatment apparatus comprises: a light source including a plurality of rodlike flash lamps arranged in a plane; a chamber provided under the light source for receiving a substrate therein; a holding element for holding the substrate within the chamber; a light-transmittable plate provided in an upper portion of the chamber for introducing a flash of light emitted from the light source into the chamber; and a clamp member for pressing the light-transmittable plate against the chamber, the clamp member having an elliptical opening.

The heat treatment apparatus is capable of increasing the temperature of parts of a substrate peripheral portion close to edge portions of the opening of the clamp member which are located on the minor axis thereof when the substrate is exposed to the flash of light to improve the within-wafer uniformity of a temperature distribution of the substrate during the heat treatment, especially the temperature distribution uniformity in the substrate peripheral portion. Additionally, the clamp member has good workability.

It is therefore an object of the present invention to provide a heat treatment apparatus capable of improving the within-wafer uniformity of a temperature distribution of a substrate during heat treatment, especially the temperature distribution uniformity in a substrate peripheral portion.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side sectional view showing the construction of a heat treatment apparatus according to the present invention;

FIG. 2 is a sectional view showing a gas passage in the heat treatment apparatus of FIG. 1;

FIG. 3 is a plan view showing a hot plate in the heat treatment apparatus of FIG. 1;

FIG. 4 is a side sectional view showing the construction of the heat treatment apparatus of FIG. 1;

FIG. 5 is a plan view showing a clamp ring in the heat treatment apparatus of FIG. 1;

FIG. 6 is a plan view showing a chamber with the clamp ring mounted thereto;

FIG. 7 is a sectional view taken along the line A-A of FIG. 6;

FIG. 8 is a sectional view taken along the line B-B of FIG. 6;

FIG. 9A shows a temperature distribution of a semiconductor wafer when a circular optical window is used;

FIG. 9B shows a temperature distribution of a semiconductor wafer when an elliptical optical window is used; and

FIGS. 10, 11 and 12 are plan views showing modifications of the clamp ring.

### DESCRIPTION OF THE PREFERRED EMBODIMENTS

A preferred embodiment according to the present invention will now be described in detail with reference to the drawings.

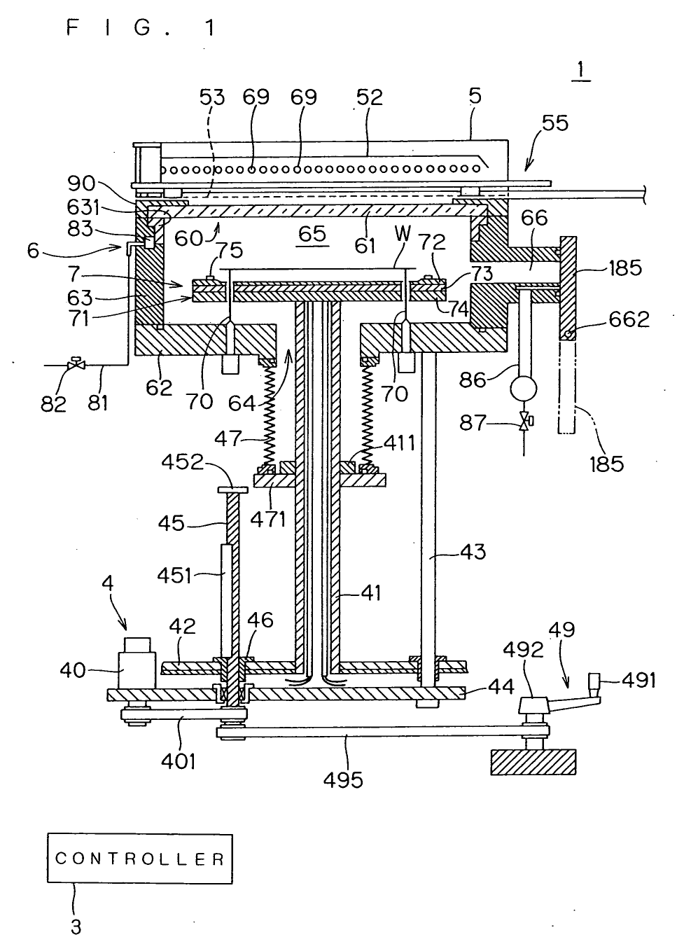

First, the overall construction of a heat treatment apparatus according to the present invention will be outlined. FIG. 1 is a side sectional view showing the construction of a heat treatment apparatus 1 according to the present invention. The heat treatment apparatus 1 is a flash lamp annealer for exposing a semiconductor wafer W serving as a substrate to a flash of light to heat the semiconductor wafer W.

The heat treatment apparatus 1 comprises a chamber 6 of a generally cylindrical configuration for receiving a semiconductor wafer W therein. The chamber 6 includes a chamber side portion 63 having an inner wall of a generally cylindrical configuration, and a chamber bottom portion 62 for covering a bottom portion of the chamber side portion 63. A space surrounded by the chamber side portion 63 and the chamber bottom portion 62 is defined as a heat treatment space 65. A top opening 60 is formed over the heat treatment space 65.

The heat treatment apparatus 1 further comprises: a light-transmittable plate 61 serving as a closure member mounted in the top opening 60 for closing the top opening 60; a holding part 7 of a generally disk-shaped configuration for preheating a semiconductor wafer W while holding the semiconductor wafer W within the chamber 6; a holding part elevating mechanism 4 for moving the holding part 7 upwardly and downwardly relative to the chamber bottom portion 62 serving as the bottom surface of the chamber 6; a light emitting part 5 for directing light through the light-transmittable plate 61 onto the semiconductor wafer W held by the holding part 7 to heat the semiconductor wafer W; and a controller 3 for controlling the above-mentioned components to perform heat treatment.

The chamber 6 is provided under the light emitting part 5. The light-transmittable plate 61 provided in an upper portion of the chamber 6 is a disk-shaped member made of, for example, quartz, and allows light emitted from the light emitting part 5 to travel therethrough into the heat treatment space 65. The chamber bottom portion 62 and the chamber side portion 63 which constitute the main body of the chamber 6 are made of a metal material having high strength and high heat resistance such as stainless steel and the like. A ring 631 provided in an upper portion of the inner side surface of the chamber side portion 63 is made of an aluminum (Al) alloy and the like having greater durability against degradation resulting from exposure to light than stainless steel.

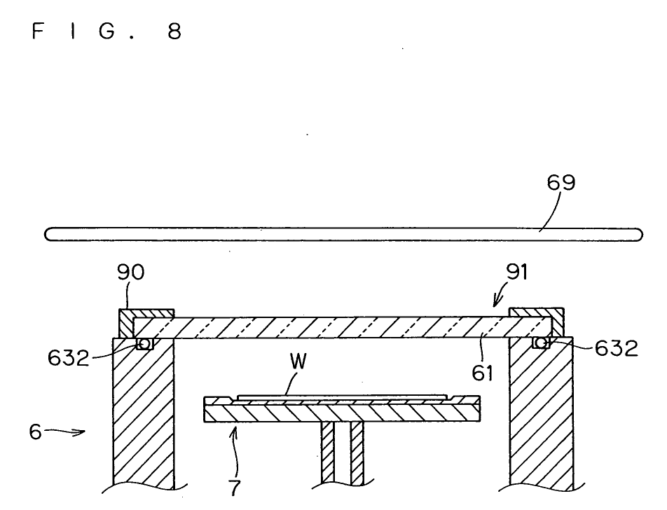

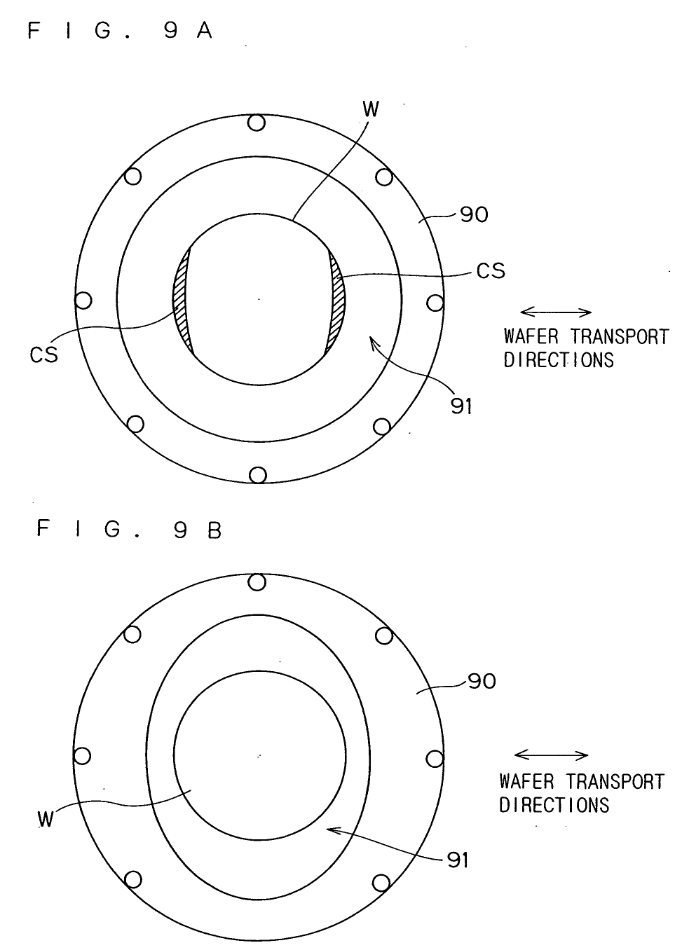

An O-ring 632 (see FIGS. 7 and 8) provides a seal between the light-transmittable plate 61 and the chamber side portion 63 so as to maintain the hermeticity of the heat treatment space 65. Specifically, an annular groove is formed in the upper end of the chamber side portion 63 of the generally cylindrical configuration, and the O-ring 632 is fitted in the annular groove and pressed down by the light-transmittable plate 61. For the purpose of holding the O-ring 632 in intimate contact between a lower peripheral portion of the light-transmittable plate 61 and the chamber side portion 63, a clamp ring 90 abuts against an upper peripheral portion of the light-transmittable plate 61 and is secured to the chamber side portion 63 by screws, thereby forcing the light-transmittable plate 61 against the O-ring 632.

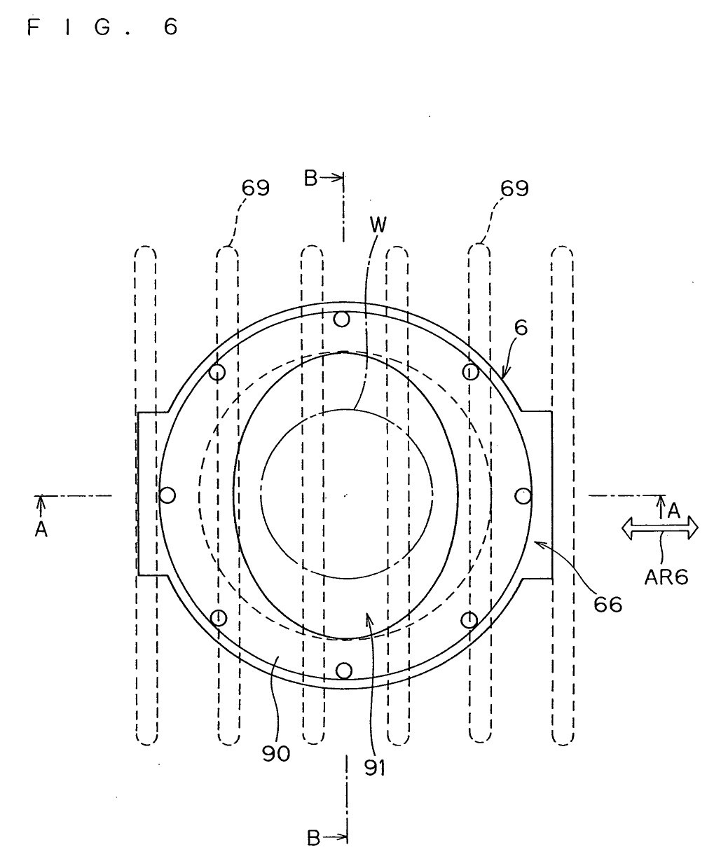

FIG. 5 is a plan view showing the clamp ring 90. The clamp ring 90 is made of aluminum or an aluminum alloy having high resistance to the degradation resulting from exposure to a flash of light. The clamp ring 90 is an annular frame element having an opening 91 of an elliptical plan configuration. A peripheral portion of the clamp ring 90 is provided with eight screw holes 92 equally spaced 45° apart from each other for securing the clamp ring 90 to the chamber side portion 63 by screws. The clamp ring 90 is secured to the chamber side portion 63 by screws to mount the light-transmittable plate 61 to the chamber 6, whereby an optical window in the light-transmittable plate 61 through which light is allowed to actually pass is defined by the opening 91 of the clamp ring 90. In this preferred embodiment, because the opening 91 is elliptical in configuration, the optical window defined by the clamp ring 90 is also of an elliptical plan configuration.

The chamber bottom portion 62 is provided with a plurality of (in this preferred embodiment, three) upright support pins 70 extending through the holding part 7 for supporting the lower surface (a surface opposite from a surface onto which light is directed from the light emitting part 5) of the semiconductor wafer W. The support pins 70 are made of, for example, quartz, and are easy to replace because the support pins 70 are fixed externally of the chamber 6.

The chamber side portion 63 includes a transport opening 66 for the transport of the semiconductor wafer W therethrough into and out of the chamber 6. The transport opening 66 is openable and closable by a gate valve 185 pivoting about an axis 662. An inlet passage 81 for introducing a processing gas (for example, an inert gas including nitrogen (N₂) gas, helium (He) gas, argon (Ar) gas and the like, or oxygen (O₂) gas and the like) into the heat treatment space 65 is formed on the opposite side of the chamber side portion 63 from the transport opening 66. The inlet passage 81 has a first end connected through a valve 82 to a gas supply mechanism not shown, and a second end connected to a gas inlet channel 83 formed inside the chamber side portion 63. The transport opening 66 is provided with an outlet passage 86 for exhausting the gas from the interior of the heat treatment space 65. The outlet passage 86 is connected through a valve 87 to an exhaust mechanism not shown.

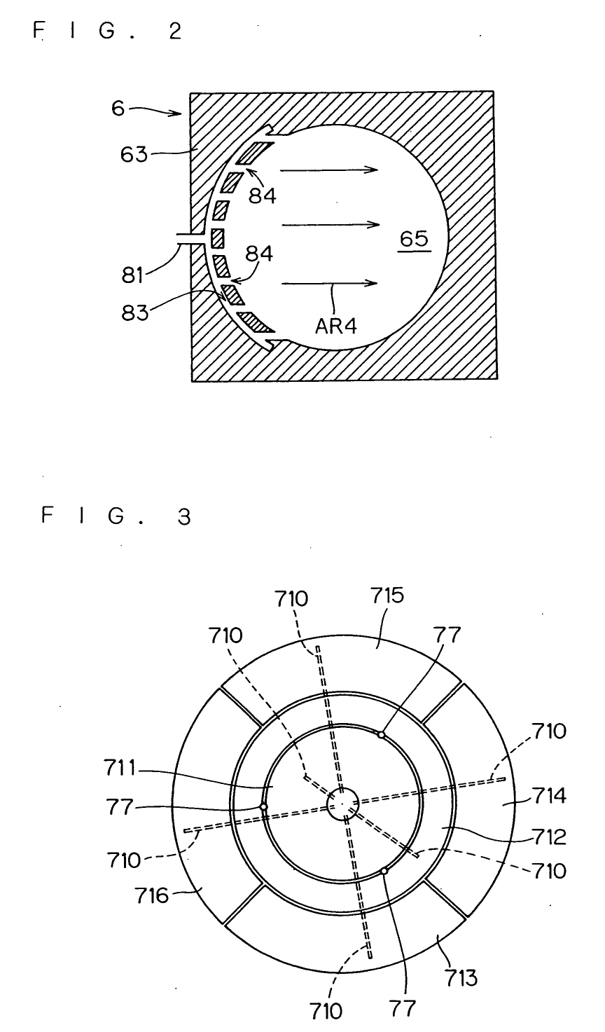

FIG. 2 is a sectional view of the chamber 6 taken along a horizontal plane at the level of the gas inlet channel 83. As shown in FIG. 2, the gas inlet channel 83 extends over approximately one-third of the inner periphery of the chamber side portion 63 on the opposite side from the transport opening 66 shown in FIG. 1. The processing gas introduced through the inlet passage 81 to the gas inlet channel 83 is fed through a plurality of gas feed holes 84 into the heat treatment space 65.

The holding part elevating mechanism 4 shown in FIG. 1 includes a shaft 41 of a generally cylindrical configuration, a movable plate 42, guide members 43 (three guide members 43 are actually provided around the shaft 41 in this preferred embodiment), a fixed plate 44, a ball screw 45, a nut 46, and a motor 40. The chamber bottom portion 62 serving as the bottom portion of the chamber 6 is formed with a bottom opening 64 of a generally circular configuration having a diameter smaller than that of the holding part 7. The shaft 41 made of stainless steel is inserted through the bottom opening 64 and connected to the lower surface of the holding part 7 (a hot plate 71 of the holding part 7 in a strict sense) to support the holding part 7.

The nut 46 for threaded engagement with the ball screw 45 is fixed to the movable plate 42. The movable plate 42 is slidably guided by the guide member 43 fixed to the chamber bottom portion 62 and extending downwardly therefrom, and is vertically movable. The movable plate 42 is coupled through the shaft 41 to the holding part 7.

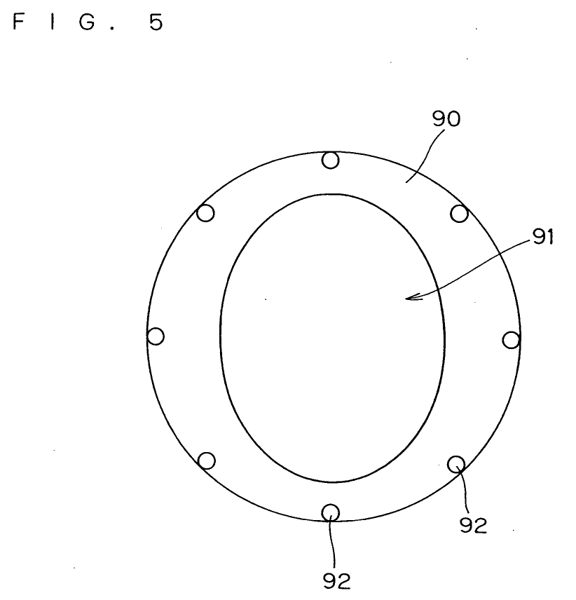

The motor 40 is provided on the fixed plate 44 mounted to the lower end portion of the guide member 43, and is connected to the ball screw 45 through a timing belt 401. When the holding part elevating mechanism 4 moves the holding part 7 upwardly and downwardly, the motor 40 serving as a driver rotates the ball screw 45 under the control of the controller 3 to move the movable plate 42 fixed to the nut 46 vertically along the guide member 43. As a result, the shaft 41 fixed to the movable plate 42 moves vertically, whereby the holding part 7 connected to the shaft 41 smoothly moves upwardly and downwardly between a transfer position shown in FIG. 1 in which the semiconductor wafer W is transferred and a heat treatment position shown in FIG. 4 in which the semiconductor wafer W is heat-treated.

An upright mechanical stopper 451 of a generally semi-cylindrical configuration (obtained by cutting a cylinder in half in a longitudinal direction) is provided on the upper surface of the movable plate 42 so as to extend along the ball screw 45. If the movable plate 42 is to move upwardly beyond a predetermined upper limit because of any anomaly, the upper end of the mechanical stopper 451 strikes an end plate 452 provided at an end portion of the ball screw 45, whereby the abnormal upward movement of the movable plate 42 is prevented. This avoids the upward movement of the holding part 7 above a predetermined position lying under the light-transmittable plate 61, to thereby prevent a collision between the holding part 7 and the light-transmittable plate 61.

The holding part elevating mechanism 4 further includes a manual elevating part 49 for manually moving the holding part 7 upwardly and downwardly during the maintenance of the interior of the chamber 6. The manual elevating part 49 has a handle 491 and a rotary shaft 492. Rotating the rotary shaft 492 by means of the handle 491 causes the rotation of the ball screw 45 connected through a timing belt 495 to the rotary shaft 492, thereby moving the holding part 7 upwardly and downwardly.

An expandable/contractible bellows 47 surrounding the shaft 41 and extending downwardly from the chamber bottom portion 62 is provided under the chamber bottom portion 62, and has an upper end connected to the lower surface of the chamber bottom portion 62. The bellows 47 has a lower end mounted to a bellows lower end plate 471. The bellows lower end plate 471 is screw-held and mounted to the shaft 41 by a collar member 411. The bellows 47 contracts when the holding part elevating mechanism 4 moves the holding part 7 upwardly relative to the chamber bottom portion 62, and expands when the holding part elevating mechanism 4 moves the holding part 7 downwardly. When the holding part 7 moves upwardly and downwardly, the bellows 47 contracts and expands to maintain the heat treatment space 65 hermetically sealed.

The holding part 7 includes the hot plate 71 for preheating (or assist-heating) the semiconductor wafer W, and a susceptor 72 provided on the upper surface (a surface on which the holding part 7 holds the semiconductor wafer W) of the hot plate 71. The shaft 41 for moving the holding part 7 upwardly and downwardly as mentioned above is connected to the lower surface of the holding part 7. The susceptor 72 is made of quartz (or may be made of aluminum nitride (AlN) or the like). Pins 75 for preventing the semiconductor wafer W from shifting out of place are mounted on the upper surface of the susceptor 72. The susceptor 72 is provided on the hot plate 71, with the lower surface of the susceptor 72 in face-to-face contact with the upper surface of the hot plate 71. Thus, the susceptor 72 diffuses heat energy from the hot plate 71 to transfer the heat energy to the semiconductor wafer W placed on the upper surface of the susceptor 72, and is removable from the hot plate 71 for cleaning during maintenance.

The hot plate 71 includes an upper plate 73 and a lower plate 74 both made of stainless steel. Resistance heating wires such as nichrome wires for heating the hot plate 71 are provided between the upper plate 73 and the lower plate 74, and an electrically conductive brazing metal containing nickel (Ni) fills the space between the upper plate 73 and the lower plate 74 to seal the resistance heating wires therewith. The upper plate 73 and the lower plate 74 have brazed or soldered ends.

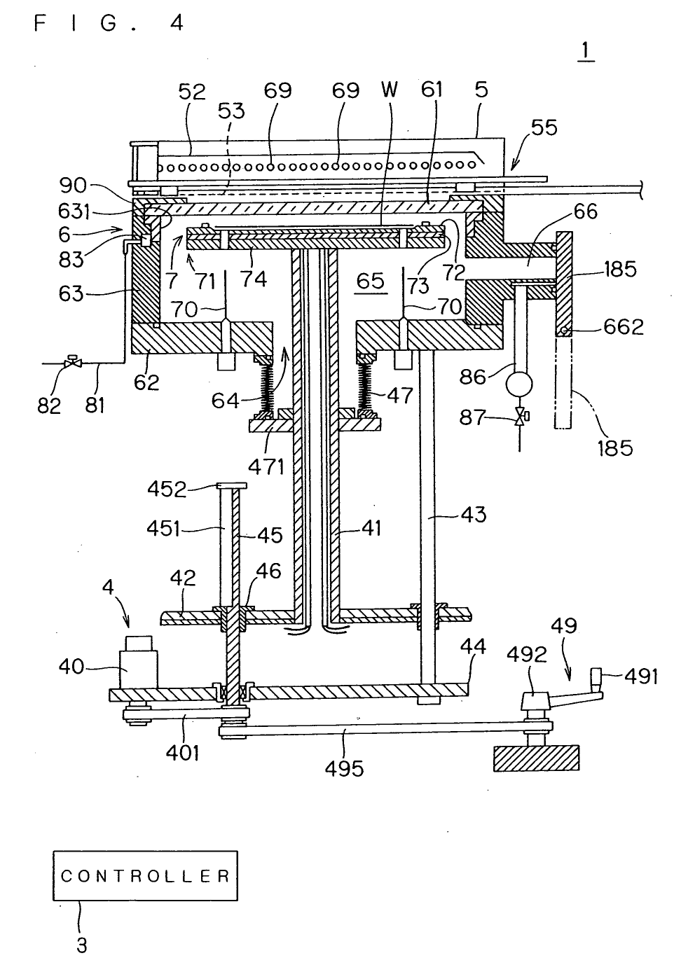

FIG. 3 is a plan view of the hot plate 71. As shown in FIG. 3, the hot plate 71 has a circular zone 711 and an annular zone 712 arranged in concentric relation with each other and positioned in a central portion of a region opposed to the semiconductor wafer W held by the holding part 7, and four zones 713 to 716 into which a substantially annular region surrounding the zone 712 is circumferentially equally divided. Slight gaps are formed between these zones 711 to 716. The hot plate 71 is provided with three through holes 77 receiving the respective support pins 70 therethrough and circumferentially spaced 120° apart from each other in a gap between the zones 711 and 712.

In the six zones 711 to 716, the resistance heating wires independent of each other are disposed so as to make a circuit to form heaters, respectively. The heaters incorporated in the respective zones 711 to 716 individually heat the respective zones. The semiconductor wafer W held by the holding part 7 is heated by the heaters incorporated in the six zones 711 to 716. A sensor 710 for measuring the temperature of each zone by using a thermocouple is provided in each of the zones 711 to 716. The sensors 710 pass through the interior of the generally cylindrical shaft 41 and are connected to the controller 3.

For heating the hot plate 71, the controller 3 controls the amount of power supply to the resistance heating wires provided in the respective zones 711 to 716 so that the temperatures of the six zones 711 to 716 measured by the sensors 710 reach a previously set predetermined temperature. The temperature control in each zone by the controller 3 is PID (Proportional, Integral, Derivative) control. In the hot plate 71, the temperatures of the respective zones 711 to 716 are continually measured until the heat treatment of the semiconductor wafer W (the heat treatment of all semiconductor wafers W when the plurality of semiconductor wafers W are successively heat-treated) is completed, and the amounts of power supply to the resistance heating wires provided in the respective zones 711 to 716 are individually controlled, that is, the temperatures of the heaters incorporated in the respective zones 711 to 716 are individually controlled, whereby the temperatures of the respective zones 711 to 716 are maintained at the set temperature. The set temperature for the zones 711 to 716 may be changed by an individually set offset value from a reference temperature.

The resistance heating wires provided in the six zones 711 to 716 are connected through power lines passing through the interior of the shaft 41 to a power source (not shown). The power lines extending from the power source to the zones 711 to 716 are disposed inside a stainless tube filled with an insulator of magnesia (magnesium oxide) or the like so as to be electrically insulated from each other. The interior of the shaft 41 is open to the atmosphere.

The light emitting part 5 shown in FIG. 1 is a light source including a plurality of (in this preferred embodiment, 30) xenon flash lamps (referred to simply as “flash lamps” hereinafter) 69, and a reflector 52. The plurality of flash lamps 69 each of which is a rodlike lamp having an elongated cylindrical configuration are arranged in a plane so that the longitudinal directions of the respective flash lamps 69 are in parallel with each other along a major surface of the semiconductor wafer W held by the holding part 7. The reflector 52 is provided over the plurality of flash lamps 69 to cover all of the flash lamps 69. The surface of the reflector 52 is roughened by abrasive blasting to produce a stain finish thereon. A light diffusion plate 53 (or a diffuser) is made of quartz glass having a surface subjected to a light diffusion process, and is provided on the lower surface side of the light emitting part 5, with a predetermined spacing held between the light diffusion plate 53 and the light-transmittable plate 61. The heat treatment apparatus 1 further comprises an emitting part movement mechanism 55 for moving the light emitting part 5 upwardly relative to the chamber 6 and then for sliding the light emitting part 5 in a horizontal direction during maintenance.

Each of the xenon flash lamps 69 includes a glass tube containing xenon gas sealed therein and having positive and negative electrodes provided on opposite ends thereof and connected to a capacitor, and a trigger electrode wound on the outer peripheral surface of the glass tube. Because the xenon gas is electrically insulative, no current flows in the glass tube in a normal state. However, if a high voltage is applied to the trigger electrode to produce an electrical breakdown, electricity stored in the capacitor flows momentarily in the glass tube, and the Joule heat evolved at this time heats the xenon gas to cause light emission. The xenon flash lamps 69 have the property of being capable of emitting much intenser light than a light source that stays lit continuously because previously stored electrostatic energy is converted into an ultrashort light pulse ranging from 0.1 millisecond to 10 milliseconds.

The heat treatment apparatus 1 according to this preferred embodiment includes various cooling structures (not shown) to prevent an excessive temperature rise in the chamber 6 and the light emitting part 5 because of the heat energy generated from the flash lamps 69 and the hot plate 71 during the heat treatment of the semiconductor wafer W. As an example, the chamber side portion 63 and the chamber bottom portion 62 of the chamber 6 are provided with a water cooling tube, and the light emitting part 5 is provided with a supply pipe for supplying a gas to the interior thereof and an exhaust pipe with a silencer to form an air cooling structure. Compressed air is supplied to the gap between the light-transmittable plate 61 and the light diffusion plate 53 of the light emitting part 5 to cool down the light emitting part 5 and the light-transmittable plate 61 and to remove organic materials and the like present in the gap therefrom to suppress the deposition of the organic materials and the like to the light diffusion plate 53 and the light-transmittable plate 61 during the heat treatment.

Next, a procedure for treating the semiconductor wafer W in the heat treatment apparatus 1 will be briefly described. The semiconductor wafer W to be treated herein is a semiconductor substrate doped with impurities by an ion implantation process. The activation of the implanted impurities is achieved by the heat treatment of the heat treatment apparatus 1.

First, the holding part 7 is placed in a position close to the chamber bottom portion 62, as shown in FIG. 1. The position of the holding part 7 shown in FIG. 1 within the chamber 6 is referred to hereinafter as a “transfer position.” When the holding part 7 is in the transfer position, the upper ends of the support pins 70 protrude through the holding part 7 upwardly out of the holding part 7.

Next, the valve 82 and the valve 87 are opened to introduce nitrogen gas at room temperature into the heat treatment space 65 of the chamber 6. Subsequently, the transport opening 66 is opened, and a transport robot outside the apparatus transports the ion-implanted semiconductor wafer W through the transport opening 66 into the chamber 6 and places the semiconductor wafer W onto the plurality of support pins 70.

The amount of nitrogen gas fed into the chamber 6 during the transport of the semiconductor wafer W into the chamber 6 shall be about 40 liters per minute. The nitrogen gas fed in the chamber 6 flows from the gas inlet channel 83 in a direction indicated by the arrow AR4 of FIG. 2, and is exhausted through the outlet passage 86 and the valve 87 shown in FIG. 1 by using a utility exhaust system. Part of the nitrogen gas fed into the chamber 6 is also exhausted from an exhaust port (not shown) provided inside the bellows 47. In steps to be described below, the nitrogen gas always continues to be fed into and exhausted from the chamber 6, and the amount of nitrogen gas fed into the chamber 6 is changed to various amounts in accordance with the process steps of the semiconductor wafer W.

After the semiconductor wafer W is transported into the chamber 6, the gate valve 185 closes the transport opening 66. Next, as shown in FIG. 4, the holding part elevating mechanism 4 moves the holding part 7 upwardly to a position (referred to hereinafter as a “heat treatment position”) close to the light-transmittable plate 61. Then, the semiconductor wafer W is transferred from the support pins 70 to the susceptor 72 of the holding part 7, and is placed and held on the upper surface of the susceptor 72.

Each of the six zones 711 to 716 of the hot plate 71 is already heated up to a predetermined temperature by the resistance heating wire individually provided within each of the zones 711 to 716 (between the upper plate 73 and the lower plate 74). The holding part 7 is moved upwardly to the heat treatment position and the semiconductor wafer W comes in contact with the holding part 7, whereby the semiconductor wafer W is preheated and the temperature of the semiconductor wafer W increases gradually.

Preheating the semiconductor wafer W in the heat treatment position for about 60 seconds increases the temperature of the semiconductor wafer W up to a previously set preheating temperature T1. The preheating temperature T1 shall range from about 200° C. to about 600° C., preferably from about 350° C. to about 550° C., at which there is no apprehension that the impurities implanted in the semiconductor wafer W are diffused by heat. A distance between the holding part 7 and the light-transmittable plate 61 is adjustable to any value by controlling the amount of rotation of the motor 40 of the holding part elevating mechanism 4.

After a lapse of the preheating time of about 60 seconds, a flash of light is emitted from the light emitting part 5 toward the semiconductor wafer W under the control of the controller 3 while the holding part 7 remains in the heat treatment position. Part of the light emitted from the flash lamps 69 of the light emitting part 5 travels directly to the interior of the chamber 6. The remainder of the light is reflected by the reflector 52, and the reflected light travels to the interior of the chamber 6. Such emission of the flash of light achieves the flash heating of the semiconductor wafer W. The flash heating, which is achieved by the emission of a flash of light from the flash lamps 69, can raise the surface temperature of the semiconductor wafer W in a short time.

Specifically, the light emitted from the flash lamps 69 of the light emitting part 5 is an intense flash of light emitted for an extremely short period of time ranging from about 0.1 millisecond to about 10 milliseconds because the previously stored electrostatic energy is converted into such an ultrashort light pulse. The surface temperature of the semiconductor wafer W subjected to the flash heating by the emission of the flash of light from the flash lamps 69 momentarily rises to a heat treatment temperature T2 of about 1000° C. to about 1100° C. After the impurities implanted in the semiconductor wafer W are activated, the surface temperature decreases rapidly. Because of the capability of increasing and decreasing the surface temperature of the semiconductor wafer W in an extremely short time, the heat treatment apparatus 1 can achieve the activation of the impurities while suppressing the diffusion of the impurities implanted in the semiconductor wafer W due to heat. Such a diffusion phenomenon is also known as a round or dull profile of the impurities implanted in the semiconductor wafer W. Because the time required for the activation of the implanted impurities is extremely short as compared with the time required for the thermal diffusion of the implanted impurities, the activation is completed in a short time ranging from about 0.1 millisecond to about 10 milliseconds during which no diffusion occurs.

Preheating the semiconductor wafer W by the holding part 7 prior to the flash heating allows the emission of the flash of light from the flash lamps 69 to rapidly increase the surface temperature of the semiconductor wafer W up to the heat treatment temperature T2.

After waiting in the heat treatment position for about 10 seconds following the completion of the flash heating, the holding part 7 is moved downwardly again to the transfer position shown in FIG. 1 by the holding part elevating mechanism 4, and the semiconductor wafer W is transferred from the holding part 7 to the support pins 70. Subsequently, the gate valve 185 opens the transport opening 66 having been closed, and the transport robot outside the apparatus transports the semiconductor wafer W placed on the support pins 70 outwardly. Thus, the flash heating process of the semiconductor wafer W in the heat treatment apparatus 1 is completed.

As discussed above, the nitrogen gas is continuously fed to the chamber 6 during the heat treatment of the semiconductor wafer W in the heat treatment apparatus 1. The amount of nitrogen gas fed into the chamber 6 shall be about 30 liters per minute when the holding part 7 is in the heat treatment position, and be about 40 liters per minute when the holding part 7 is in other than the heat treatment position.

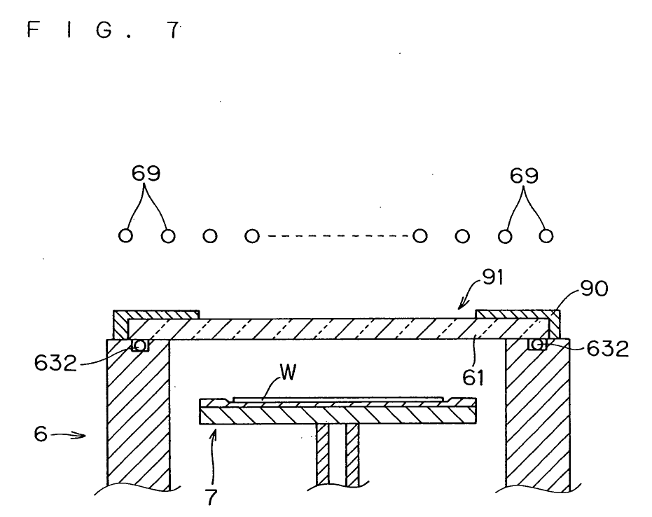

In the heat treatment apparatus 1 according to this preferred embodiment, the opening 91 of the clamp ring 90 has an elliptical configuration, and the optical window of the light-transmittable plate 61 accordingly has an elliptical plan configuration. The technical significance of such a configuration will be described. FIG. 6 is a plan view of the chamber 6 with the clamp ring 90 mounted thereto. FIG. 7 is a sectional view taken along the line A-A of FIG. 6 (i.e., a sectional view taken along the minor axis of the elliptical opening 91). FIG. 8 is a sectional view taken along the line B-B of FIG. 6 (i.e., a sectional view taken along the major axis of the elliptical opening 91).

As shown in FIGS. 6 through 8, the clamp ring 90 in the heat treatment apparatus 1 according to this preferred embodiment is mounted to the chamber 6 so that the major axis of the elliptical configuration of the opening 91 extends along the longitudinal direction of the flash lamps 69 of the light emitting part 5. In the plane of FIG. 6, the transport opening 66 is formed on the right-hand side of the chamber 6, and the semiconductor wafer W is transported into and out of the chamber 6 in directions indicated by a double-headed arrow AR6 by the transport robot. The directions (also referred to hereinafter as “wafer transport directions”) in which the semiconductor wafers W is transported into and out of the chamber 6 (or the directions indicated by the double-headed arrow AR6) coincide with a direction in which the minor axis of the elliptical configuration of the opening 91 extends.

As shown in FIGS. 6 and 7, a pair of first opposite edge portions of the elliptical optical window defined by the opening 91 of the clamp ring 90 which are located on the minor axis are disposed inwardly of the inner wall surface of the chamber 6 (i.e., the inner wall surface of the chamber side portion 63) and outwardly of the peripheral edge of the semiconductor wafer W held by the holding part 7, as seen in plan view. As shown in FIGS. 6 and 8, on the other hand, a pair of second opposite edge portions of the elliptical optical window which are located on the major axis are substantially in the same position as the inner wall surface of the chamber 6, as seen in plan view. The remaining edge portions of the optical window are located between the first edge portions and the second edge portions. The second edge portions of the elliptical optical window may be disposed slightly inwardly or outwardly of the inner wall surface of the chamber 6, as seen in plan view.

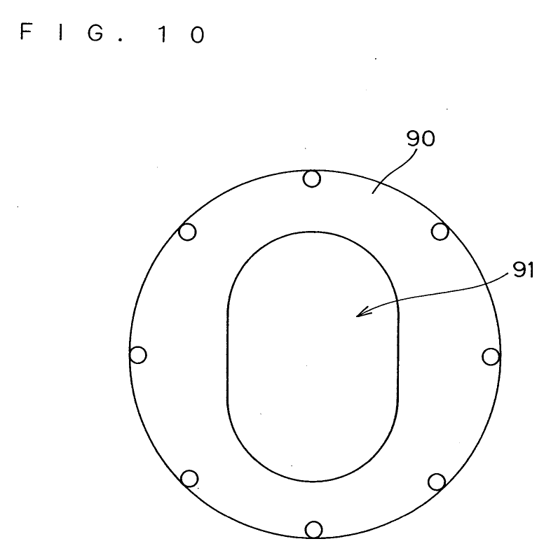

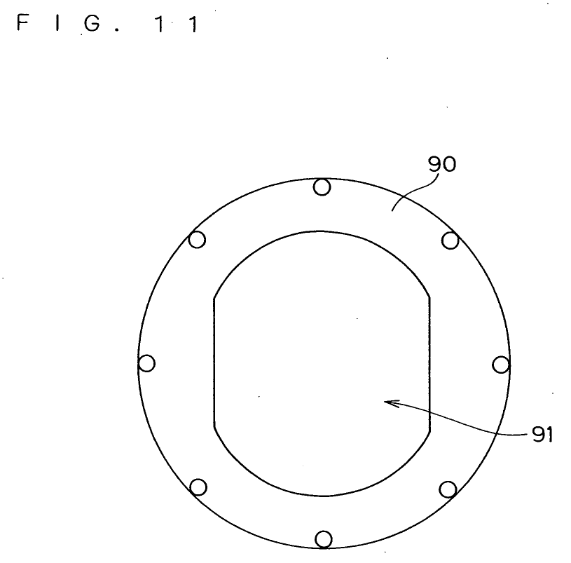

In the conventional techniques, the opening 91 of the clamp ring 90 has been of a circular plan configuration. The optical window defined by the clamp ring 90 is accordingly of a circular plan configuration. It has been found that a flash of light directed from the flash lamps 69 of the light emitting part 5 through such a circular optical window creates low temperature regions CS (shaded regions in FIG. 9A) relatively lower in temperature than other regions in a peripheral portion of the semiconductor wafer W, as shown in FIG. 9A. Such low temperature regions CS are known as cold spots and cause a treatment failure. Conceivable factors responsible for the creation of non-uniform temperature regions such as the low temperature regions CS include the configuration of the chamber 6 which is substantially cylindrical but is not truly cylindrical because of the presence of the transport opening 66, the gas inlet channel 83 and the like, and the configuration of the flash lamps 69 of the light emitting part 5 which are not point light sources but are rodlike lamps. That is, the low temperature regions CS are considered to appear in specific locations of the semiconductor wafer W because of geometrical factors inherent in the apparatus such as the configuration of the chamber 6 itself and the configuration and arrangement of the flash lamps 69. In the heat treatment apparatus 1 according to this preferred embodiment, the low temperature regions CS appear in opposite edge portions in the peripheral portion of the semiconductor wafer W, the opposite edge portions being arranged in the wafer transport directions (or in a direction perpendicular to the longitudinal direction of the flash lamps 69). The low temperature regions CS appearing in parts of the peripheral portion of the semiconductor wafer W cannot be eliminated by the adjustment of the temperature of the hot plate 71.

To solve the problem, this preferred embodiment features the clamp ring 90 which has the opening 91 of the elliptical plan configuration, and which is fixed to the chamber 6 so that the direction of the minor axis of the elliptical opening 91 coincides with the wafer transport directions, as shown in FIG. 6. This causes the optical window defined by the clamp ring 90 to have an elliptical plan configuration, and causes the direction of the minor axis of the elliptical optical window to coincide with the wafer transport directions. In other words, opposite edge portions of an optical window of a circular plan configuration facing respective parts of the peripheral portion of the semiconductor wafer W which have a relatively low temperature if exposed to a flash of light directed from the flash lamps 69 through the circular optical window are shifted toward the center of the optical window so that a distance between the center of the optical window and the above-mentioned opposite edge portions of the optical window is shorter than a distance between the center of the optical window and any other edge portion of the optical window.

Directing a flash of light from the flash lamps 69 through such an elliptical optical window prevents the creation of the low temperature regions CS as shown in FIG. 9B to improve the within-wafer uniformity of a temperature distribution of the semiconductor wafer W during the flash heating, especially the temperature distribution uniformity in the peripheral portion of the wafer W. The reason is considered to be that multiple reflections of a flash of light emitted from the flash lamps 69 and reflected from the semiconductor wafer W occur in the first edge portions of the elliptical optical window, that is, in opposed portions of the clamp ring 90 extended toward the center of the optical window, and the reflected light having undergone the multiple reflections enters the semiconductor wafer W again. Most of the reflected light having undergone the multiple reflections enters parts of the peripheral portion of the semiconductor wafer W which are closest to the opposed portions of the clamp ring 90 extended toward the center of the optical window, that is, the opposite edge portions of the semiconductor wafer W which are arranged in the wafer transport directions again. As a result, the increased amount of light entering the low temperature regions CS is considered to cause the relatively increased temperature, thereby improving the temperature distribution uniformity of the peripheral portion of the semiconductor wafer W.

As described hereinabove, this preferred embodiment employs the clamp ring 90 having the elliptical opening 91 to define the optical window of the elliptical plan configuration in conformity with the configuration of the low temperature regions CS having a relatively low temperature which appear if a flash of light is directed from the flash lamps 69 through an optical window assumed to be of a circular plan configuration. Also, this preferred embodiment brings the first edge portions of the elliptical optical window into correspondence with the low temperature regions CS. This increases the temperature of the low temperature regions CS to improve the within-wafer uniformity of the temperature distribution of the semiconductor wafer W during the flash heating. The improvement in the within-wafer uniformity of the temperature distribution of the semiconductor wafer W during the flash heating can prevent a crack in the semiconductor wafer W.

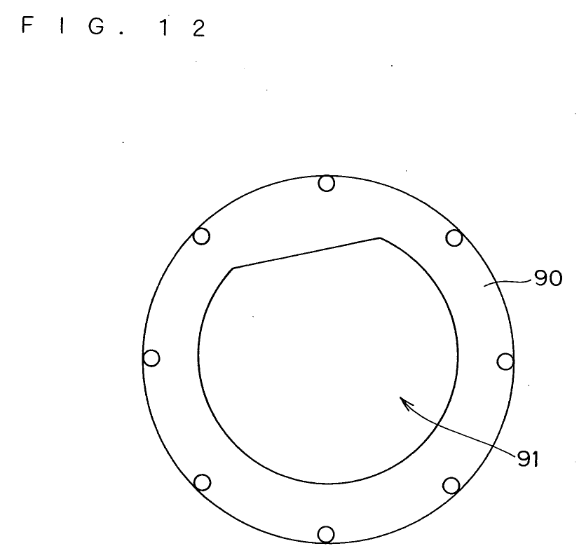

While the preferred embodiment according to the present invention has been described hereinabove, the present invention is not limited to the above-mentioned specific embodiment. For example, although the opening 91 of the clamp ring 90 is of the elliptical configuration according to the above-mentioned preferred embodiment, the opening 91 may be of an oval racetrack-shaped configuration, as shown in FIG. 10. Because of the oval racetrack-shaped configuration of the opening 91, the use of the clamp ring 90 shown in FIG. 10 causes the optical window defined by the clamp ring 90 to have an oval racetrack-shaped plan configuration. Then, the clamp ring 90 is fixed to the chamber 6 so that a direction in which the line segments of the oval racetrack-shaped configuration of the optical window extend is perpendicular to the wafer transport directions. Such a modification also enables a distance between the center of the optical window and opposite edge portions of the optical window facing the low temperature regions CS to be shorter than a distance between the center of the optical window and any other edge portion of the optical window. This increases the temperature of the low temperature regions CS during the flash heating to improve the within-wafer uniformity of the temperature distribution of the semiconductor wafer W.

In other words, effects similar to those of the above-mentioned preferred embodiment are produced when the opening 91 of the clamp ring 90 is defined so that a distance between the center of an optical window and an edge portion of the optical window facing a low temperature region CS is shorter than a distance between the center of the optical window and any other edge portion of the optical window. Thus, the opening 91 of the clamp ring 90 may have a configuration as shown in FIG. 11. The clamp ring 90 shown in FIG. 11 has the opening 91 formed by defining chords in parts of a circular opening. The clamp ring 90 is fixed to the chamber 6 so that a direction in which the line segments (or the chords) of the optical window extend is perpendicular to the wafer transport directions. Such a modification also produces effects similar to those described above. However, the clamp ring 90 has better workability when the opening 91 is of the elliptical configuration or in the oval racetrack-shaped configuration.

When the construction of the chamber 6 and the shape and arrangement of the flash lamps 69 differ from those described above, there are cases where the low temperature regions CS created when the flash heating is performed by using the optical window of the circular plan configuration are present in a different position than those in the heat treatment apparatus 1 of the above-mentioned preferred embodiment. In such cases, the opening 91 of the clamp ring 90 should be formed so that a distance between the center of the optical window and an edge portion of the optical window facing a low temperature region CS is shorter than a distance between the center of the optical window and any other edge portion of the optical window. Therefore, the clamp ring 90 having the opening 91 may have only one portion extended toward the center of the optical window, for example, as shown in FIG. 12.

The configuration of the optical window is defined by the opening 91 of the clamp ring 90 in the above-mentioned preferred embodiment. Instead, the optical window may be formed by attaching a reflective member to an upper surface or a lower surface of a peripheral portion of the light-transmittable plate 61.

Although the 30 flash lamps 69 are provided in the light emitting part 5 according to the above-mentioned preferred embodiment, the present invention is not limited to this. Any number of flash lamps 69 may be provided.

The flash lamps 69 are not limited to the xenon flash lamps but may be krypton flash lamps.

The technique according to the present invention is applicable to a heat treatment apparatus which comprises the light emitting part 5 including other types of lamps (e.g., halogen lamps) in place of the flash lamps 69 and which heats the semiconductor wafer W by exposing the semiconductor wafer W to light emitted from the lamps. In this case, making a distance between the center of the optical window and an edge portion of the optical window facing a low temperature region CS shorter than a distance between the center of the optical window and any other edge portion of the optical window improves the within-wafer uniformity of the temperature distribution of the semiconductor wafer W when the semiconductor wafer W is heat-treated by the light emission.

The hot plate 71 is used as the assist-heating element in the above-mentioned preferred embodiment. However, a group of lamps (e.g., a plurality of halogen lamps) may be provided under the holding part 7 which holds the semiconductor wafer W to emit light therefrom, thereby achieving the assist-heating.

In the above-mentioned preferred embodiment, the ion activation process is performed by exposing the semiconductor wafer to light. The substrate to be treated by the heat treatment apparatus according to the present invention is not limited to the semiconductor wafer. For example, the heat treatment apparatus according to the present invention may perform the heat treatment on a glass substrate formed with various silicon films including a silicon nitride film, a polycrystalline silicon film and the like. As an example, silicon ions are implanted into a polycrystalline silicon film formed on a glass substrate by a CVD process to form an amorphous silicon film, and a silicon oxide film serving as an anti-reflection film is formed on the amorphous silicon film. In this state, the heat treatment apparatus according to the present invention may expose the entire surface of the amorphous silicon film to light to polycrystallize the amorphous silicon film, thereby forming a polycrystalline silicon film.

Another modification may be made in a manner to be described below. A TFT substrate is prepared such that an underlying silicon oxide film and a polysilicon film produced by crystallizing amorphous silicon are formed on a glass substrate and the polysilicon film is doped with impurities such as phosphorus or boron. The heat treatment apparatus according to the present invention may expose the TFT substrate to light to activate the impurities implanted in the doping step.

While the invention has been described in detail, the foregoing description is in all aspects illustrative and not restrictive. It is understood that numerous other modifications and variations can be devised without departing from the scope of the invention.

What is claimed is:

1. A heat treatment apparatus for exposing a substrate to a flash of light to heat the substrate, comprising:
a light source including a plurality of flash lamps arranged in a plane;
a chamber provided under said light source for receiving a substrate therein;
a holding element for holding the substrate within said chamber;
a light-transmittable plate provided in an upper portion of said chamber for introducing a flash of light emitted from said light source into said chamber; and
an optical window forming member for defining an optical window, said optical window being a region of said light-transmittable plate through which light actually passes, said optical window having a plan configuration such that a distance between the center of said optical window and an edge portion of said optical window is shorter than a distance between the center of said optical window and any other edge portion of said optical window.

2. The heat treatment apparatus according to claim 1, wherein
said edge portion of said optical window is an edge portion facing part of a substrate peripheral portion having a relatively low temperature if a flash of light is directed from said light source through said optical window, assuming that said optical window is of a circular plan configuration.

3. The heat treatment apparatus according to claim 2, wherein
said optical window defined by said optical window forming member is of an elliptical plan configuration.

4. The heat treatment apparatus according to claim 3, wherein
opposite edge portions of said optical window which are located on the minor axis of the elliptical plan configuration are disposed inwardly of an inner wall surface of said chamber and outwardly of a peripheral edge of the substrate held by said holding element, as seen in plan view.

5. The heat treatment apparatus according to claim 2, wherein
said optical window defined by said optical window forming member is of an oval racetrack-shaped plan configuration.

6. The heat treatment apparatus according to claim 1, wherein
said optical window forming member is a frame for pressing said light-transmittable plate against said chamber and covering an upper surface of a peripheral portion of said light-transmittable plate, to thereby forming said optical window.

7. A heat treatment apparatus for exposing a substrate to a flash of light to heat the substrate, comprising:
a light source including a plurality of rodlike flash lamps arranged in a plane;
a chamber provided under said light source for receiving a substrate therein;
a holding element for holding the substrate within said chamber;
a light-transmittable plate provided in an upper portion of said chamber for introducing a flash of light emitted from said light source into said chamber; and
a clamp member for pressing said light-transmittable plate against said chamber, said clamp member having an elliptical opening.

8. The heat treatment apparatus according to claim 7, wherein
a direction in which the major axis of said elliptical opening extends coincides with a longitudinal direction of said flash lamps.

9. The heat treatment apparatus according to claim 7, wherein
a direction in which the minor axis of said elliptical opening extends coincides with directions in which a substrate is transported into and out of said chamber.

10. The heat treatment apparatus according to claim 7, wherein
said clamp member is made of an aluminum alloy.
